(19) United States
(12) Patent Application Publication
(10) Pub. No.: US 2026/0091723 A1
(43) Pub. Date: Apr. 2, 2026

(54) LOADING ASSEMBLY FOR TRAILERS AND VEHICLES

(71) Applicant: Justin PARHAM, Linden, AL (US)

(72) Inventor: Justin PARHAM, Linden, AL (US)

(21) Appl. No.: 18/900,296

(22) Filed: Sep. 27, 2024

(51) Int. Cl. B60P 1/43

(52) U.S. Cl. CPC B60P 1/435

(57) ABSTRACT

A loading assembly for a trailer or vehicle is provided. The loading assembly includes a ramp portion pivotally coupled to the trailer or vehicle by a spring-assisted hinge mechanism. The spring-assisted hinge mechanism facilitates movement of the ramp portion between a neutral position in which the ramp portion is elevated above a ground surface and a loading position in which the ramp portion is flush with the ground surface. The ramp portion may also include a portion that can be extended from the base to accommodate trailers or vehicles of varying heights.

### TECHNICAL FIELD

The present disclosure relates generally to loading assemblies, such as ramp assemblies, for attachment to trailers and truck beds of various sizes to facilitate loading and unloading of equipment and cargo.

### BACKGROUND

Pickup trucks, trailers, and other vehicles having a cargo-carrying bed are commonly used to transport loads which are too heavy to be manually hoisted, for example, small vehicles such as motorcycles, all-terrain vehicles, snowmobiles, jet skis, and lawn mowers, and heavy cargo, such as tractors, farm equipment, and larger machinery. Such loads are generally loaded onto the truck or trailer by pushing or driving them up a ramp and onto the open bed of the truck or trailer. One of the known problems associated with loading these types of vehicles and cargo onto a truck bed or trailer is that they are extremely heavy. Accordingly, the ramps used to load them onto a truck bed must be strong enough and sturdy enough to withstand the weight of the vehicle as well as the person or persons loading the vehicle. When ramps are built to be strong and sturdy enough to withstand the weight of a vehicle or other heavy cargo, they are often cumbersome and difficult for a user to set up, use, transport, and dismantle. Often such ramps are large.

In addition, loading the truck bed or trailer with conventional ramps can result in damage to the vehicles or other objects being loaded and injury to persons loading them. For example, when loading a vehicle onto a truck bed using a ramp, the upper edge of the ramp must typically rest solidly on the rear bumper of the truck or trailer while the vehicle is being driven up the ramp. If the upper edge overhangs the bumper somewhat, the ramp will become unstable when the weight of the front wheels of the vehicle being loaded is on the overhang. At this point, the ramp will rock and become unstable, and the driver may lose control of the vehicle.

Moreover, after the vehicle or cargo has been loaded onto the truck bed or trailer, it is ideal to transport the ramp so that the ramp can be used to unload the vehicle or cargo at the end destination. Often the ramp must be dissembled or maneuvered in such a way so that it fits onto the truck bed alongside the vehicle or cargo within the bed. This can be a difficult task to accomplish due to the size and weight of the ramp. Additionally, it is often difficult for a user to accomplish this task due to the size restrictions of the truck bed or trailer.

Accordingly, there remains a need in the art for a loading assembly that is strong and sturdy enough to withstand the weight of a vehicle or other heavy cargo to be loaded onto a truck bed or trailer and easy for the user to set up, use, and transport.

### SUMMARY

The problems expounded above, as well as others, are addressed by the following inventions, although it is to be understood that not every embodiment of the inventions described herein will address each of the problems described above. The present disclosure describes different embodiments of loading assemblies for trailers.

In some embodiments, the present disclosure provides a loading assembly for attachment to a trailer or vehicle is provided, the loading assembly including a bracket, a ramp portion pivotally coupled to the bracket, wherein the ramp portion is pivotally coupled to the bracket by a hinge mechanism, wherein the hinge mechanism includes a hinge pin and a first biasing spring and a second biasing spring disposed around the hinge pin, and the first and second biasing springs are unloaded when the ramp portion is in a neutral position and the first and second biasing springs are tensioned when the ramp portion is in a loading position, and wherein the hinge mechanism facilitates movement of the ramp portion between the neutral position in which the ramp portion is elevated above a ground surface and the loading position in which the ramp portion is level with the ground surface.

In one embodiment, the loading assembly further includes a height adjusting plate configured for attachment to an underside of the ramp portion at adjustable heights. In another embodiment, the hinge pin is mounted between the bracket and the ramp portion. In still another embodiment, the ramp portion is elevated at a height equal to or greater than a height of an axle of the trailer or vehicle when in the neutral position. In yet another embodiment, the ramp portion includes a lip configured to be flush with the ground surface in the loading position. In still another embodiment, an end of each of the first and second biasing springs bears on a lower edge of the height adjusting plate.

In further embodiments, a loading assembly for attachment to a trailer or vehicle is provided, the loading assembly including an attachment mechanism, a ramp portion including a base and an extender coupled to the base, wherein the base is pivotally coupled to the attachment mechanism by a biasing spring, an actuating mechanism operatively attached to the base and the extender, wherein the actuating mechanism is configured to facilitate extension of the extender from the base, wherein the biasing spring is unloaded when the ramp portion is in a neutral position and the biasing spring is tensioned when the ramp portion is in a loading position, and the biasing spring facilitates movement of the ramp portion between the neutral position in which the ramp portion is elevated above a ground surface and the loading position in which the ramp portion is level with the ground surface.

In one embodiment, the attachment mechanism includes a bracket or a plate configured for attachment to the trailer or vehicle. In another embodiment, each of the base and the extender includes a plurality of cross-treads extending therebetween. In still another embodiment, the extender is configured to move between a stowed position in which the extender is positioned inside the base and an extended position in which the extender is extended outwardly from the base. In yet another embodiment, the actuating mechanism includes a linear actuator. In another embodiment, the actuating mechanism includes a pneumatic or hydraulic cylinder operatively connected to a movable rod. In still another embodiment, the movable rod is operatively attached to the extender. In another embodiment, the extender includes a front plate configured to be flush with the ground surface in the loading position.

In still further embodiments, a trailer is provided, the trailer including a substantially flatbed having a rear bumper, a ramp portion pivotally coupled to the rear bumper by a hinge mechanism, wherein the ramp portion includes a base and an extender coupled to the base, an actuating mechanism operatively attached to the base and the extender, wherein the actuating mechanism is configured to facilitate extension of the extender from the base, the actuating mechanism including a linear actuator, wherein the hinge mechanism includes a hinge pin and at least one biasing spring disposed around the hinge pin, and the at least one biasing spring is unloaded when the ramp portion is in a neutral position and is tensioned when the ramp portion is in a loading position, and wherein the hinge mechanism facilitates movement of the ramp portion between the neutral position in which the ramp portion is elevated above a ground surface and the loading position in which the ramp portion is flush with the ground surface.

In one embodiment, the actuating mechanism includes a pneumatic or hydraulic cylinder operatively connected to a movable rod. In another embodiment, the movable rod is operatively attached to the extender. In still another embodiment, the trailer further includes a height adjusting plate configured for attachment to an underside of the ramp portion at adjustable heights, wherein an end of the at least one biasing spring bears on a lower edge of the height adjusting plate. In yet another embodiment, the ramp portion is elevated at a height equal to or greater than a height of an axle of the trailer when in the neutral position. In another embodiment, each of the base and the extender includes a plurality of cross-treads extending therebetween.

### BRIEF DESCRIPTION OF THE DRAWINGS

Further features and advantages can be ascertained from the following detailed description that is provided in connection with the drawings described below:

FIG. 1 is a front perspective view of a loading assembly attached to a trailer according to one embodiment of the present disclosure.

FIG. 2 is a side view of the loading assembly attached to the trailer shown in FIG. 1.

FIG. 3 is a partial front perspective view of the loading assembly shown in FIG. 1.

FIG. 4 is a partial bottom perspective view of the loading assembly shown in FIG. 1.

FIG. 5 is a front perspective view of a loading assembly attached to a trailer according to another embodiment of the present disclosure.

FIG. 6 is a front perspective view of a loading assembly attached to a trailer according to another embodiment of the present disclosure.

FIG. 7 is a side view of the loading assembly attached to the trailer shown in FIG. 6.

FIG. 8A is an exploded view of the loading assembly shown in FIG. 6.

FIG. 8B is a front perspective view of a mechanism for attaching the loading assembly to a trailer according to one embodiment of the present disclosure.

FIG. 9 is a front perspective view of the loading assembly shown in FIG. 6 in a stowed position.

FIG. 10 is a front perspective view of the loading assembly shown in FIG. 6 in an extended position.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” and the like, may be used herein for ease of description to describe one element or feature's relationship to another.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The present disclosure provides hands-free and easy to use loading assemblies for trailers and other vehicles. The loading assemblies of the present disclosure include a ramp pivotally coupled to the trailer or vehicle by a spring-assisted hinge mechanism. The spring-assisted hinge mechanism facilitates movement of the ramp between a neutral position in which the ramp is elevated above a ground surface and a loading position in which the ramp is flush with the ground surface. In some embodiments, the ramp may also include a portion that can be extended from the base to accommodate trailers and vehicles of varying heights.

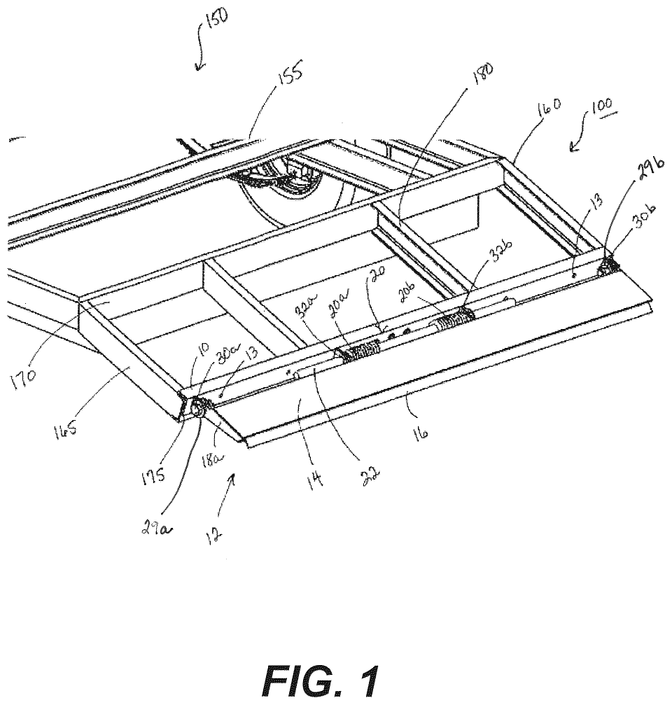

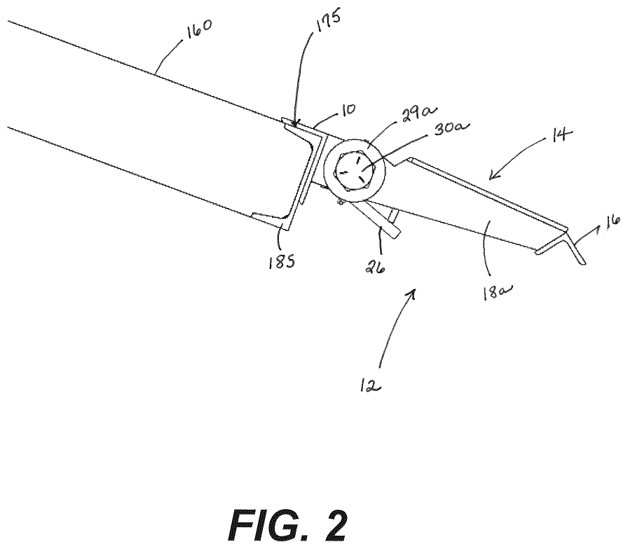

Referring to FIGS. 1-4, a loading assembly 100 according to one embodiment of the present disclosure is shown. As illustrated in FIGS. 1 and 2, the loading assembly 100 is configured for attachment to a trailer 150. The trailer 150 includes a main flatbed portion 155 and a tail portion 160 connected by a hinge (not shown). The tail portion 160 includes a frame 165 comprised of a front cross member 170 and a rear cross member 175 with a plurality of lateral members 180 spaced therebetween. The loading assembly 100 is configured for attachment to the rear cross member 175 of the tail portion 160.

For purposes of illustration, the trailer 150 shown in FIG. 1 is a trailer having a dovetail; however, the loading assembly 100 may be used with any type of trailer, such as, for example, a flatbed trailer or a straight deck trailer with or without a tail portion. In addition, although FIG. 1 depicts a trailer, the loading assembly 100 can be configured for attachment to a truck or in other circumstances where it is desirable to have a ramp attached thereto. For instance, the loading assembly 100 could be configured for attachment to a bumper or rear of a vehicle, such as a truck or tractor.

The loading assembly 100 includes a ramp portion 12 pivotally connected to a bracket 10. In the illustrated embodiment, the ramp portion 12 and the bracket 10 extend along the length of the rear cross member 175. For instance, the ramp portion 12 is a single continuous trailer ramp. The bracket 10 may include a plurality of lights 13 that can be wired to the trailer 150. The ramp portion 12 includes a generally sloped or inclined surface 14. The inclined surface 14 facilitates a smooth loading and unloading process. In some embodiments, the ramp portion 12 may be formed at an angle of about 5 degrees to about 20 degrees. In another embodiment, the ramp portion 12 may be formed at an angle of about 7 degrees to about 15 degrees. In still another embodiment, the ramp portion 12 may be formed at an angle of about 8 degrees to about 10 degrees. The inclined surface 14 may also include an outwardly directed inclined lip 16. The lip 16 is configured to engage with the ground surface when the ramp is disposed for loading to create a flush surface. In some embodiments, the ramp portion 12 may include a non-skid surface. Such surface may include coatings of various anti-slip material, for example, paints or other coatings, or may include raised projections. Any non-skid material known in the art may be used.

The ramp portion 12 is connected to the bracket 10 via two generally parallel spaced apart side plates 18a, 18b. The side plates 18a, 18b are integrally formed with the ramp portion 12. In one embodiment, the side plates 18a, 18b may also be integrally formed with the bracket 10. In another embodiment, the side plates 18a, 18b can be attached to the bracket 10 with fasteners, such as bolts, screws, or rivets. Each of the side plates 18a, 18b include a securing member 30a, 30b. The securing members 30a, 30b add pivot support and allow for side movement. As illustrated in FIGS. 1 and 2, the securing members 30a, 30b are bolts. However, other securing mechanisms may also be used. Each securing member 30a, 30b may also include a friction washer 29a, 29b. The friction washers 29a, 29b set the amount of tension when lowering or lifting the ramp portion 12. This allows for control of the movement and also prevents the ramp portion 12 from bouncing during transport.

The bracket 10 is configured for attachment to the rear cross member 175 of the tail portion 160. As shown in FIGS. 1 and 2, the bracket 10 is L-shaped such that it complements the cross-sectional shape of the rear cross member 175. However, the bracket 10 may have any suitable shape that allows for it to be attached to the rear cross member 175. In one embodiment, the bracket 10 may be attached to the rear cross member 175 with fasteners, such as bolts, screws, or rivets. The bracket 10 may include a plurality of holes configured for insertion of a fastener. For example, the bracket 10 may be bolted to the rear cross member 175. In another embodiment, the bracket 10 may be screwed to the rear cross member 175. In further embodiments, the bracket 10 may be welded to the rear cross member 175. In some embodiments, as shown in FIGS. 1 and 2, the rear cross member 175 of the tail portion 160 may be encased in a steel or metal frame 185. In this embodiment, the bracket 10 may be attached directly to the frame 185 on the rear cross member 175.

The ramp portion 12 is pivotally connected to a bracket 10 to allow for the ramp portion 12 to pivot between a neutral position and a loading position. The neutral position is shown in FIG. 1. In the neutral position, the ramp portion 12 is elevated above the ground surface. For instance, in the neutral position, the ramp portion 12 may be elevated anywhere from about one inch to about twenty-four inches off the ground surface. In another embodiment, the ramp portion 12 may be elevated about three inches to about twenty inches off the ground surface. In still another embodiment, the ramp portion 12 may be elevated about six inches to about fifteen inches off the ground surface. However, in the neutral position, the ramp portion 12 should be no lower than the height of the axle of the trailer 150. In the loading position, the ramp portion 12 pivots downward such that the lip 16 is level with the ground surface to allow for vehicles and other cargo to be loaded on the trailer. For instance, the ramp portion 12 may be flush with the ground surface. Once loading is complete, the ramp portion 12 pivots upward to the neutral position. In some embodiments, movement of the ramp portion 12 between the loading position and the neutral position is performed with the use of a spring-assisted hinge mechanism 20.

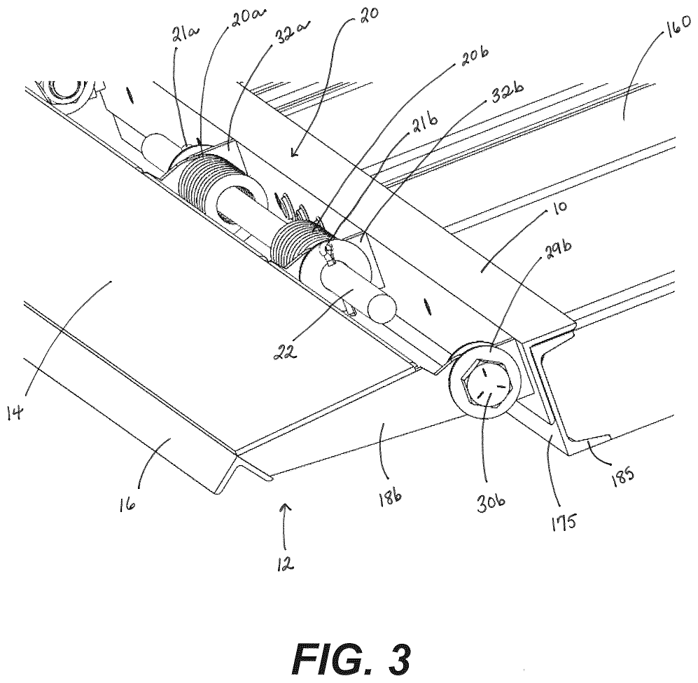

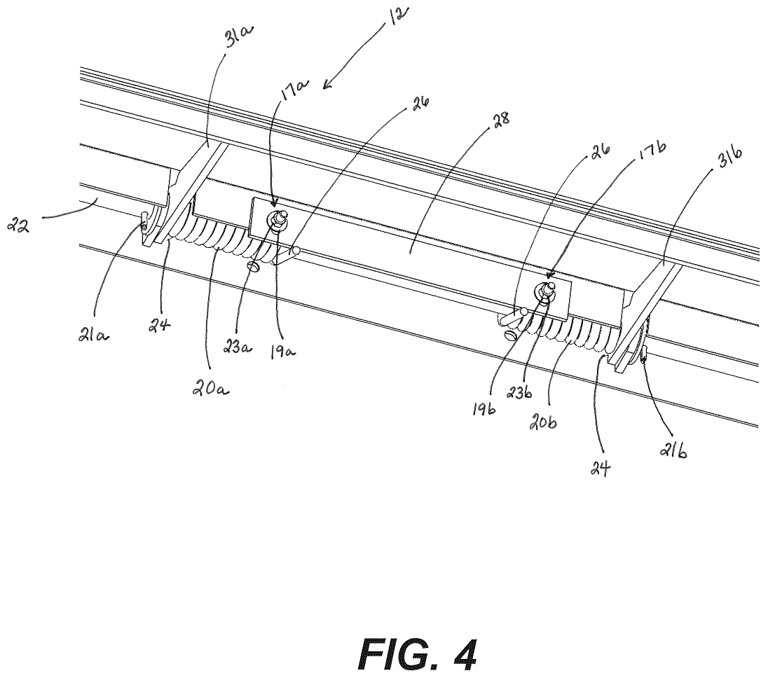

The hinge mechanism 20 pivotally couples the ramp portion 12 to the bracket 10 As illustrated in FIGS. 3 and 4, the hinge mechanism 20 includes a first biasing spring 20a and a second biasing spring 20b. In one embodiment, the first biasing spring 20a and the second biasing spring 20b are heavy duty helical elongated coil springs. The first biasing spring 20a and the second biasing spring 20b are coiled around a hinge pin 22. The hinge pin 22 extends through two brackets 32a, 32b that are mounted between the bracket 10 and the ramp portion 12. Pins 21a, 21b, such as cotter pins, can extend through the hinge pin 22 and be used to secure the hinge pin 22 to the brackets 32a, 32b. There are also two brackets 31a, 31b on the underside of the ramp portion 12 for supporting the hinge pin 22.

As best shown in FIG. 4, a first end 24 of each of the first and second biasing springs 20a, 20b bears on an underside of the ramp portion 12. A second end 26 of each of the first and second biasing springs 20a, 20b bears on a lower edge of a height adjusting plate 28. The first and second biasing springs 20a, 20b are tensioned when the ramp portion 12 is in the loading position while the first and second biasing springs 20a, 20b are unloaded in the neutral position. In other words, the first and second biasing springs 20a, 20b of the hinge mechanism 20 biases the ramp portion 12 toward the neutral position. As will be appreciated by those skilled in the art, increasing the strength or number of biasing springs could be utilized as desired to provide additional force in favor of the neutral position.

The height adjusting plate 28, as shown in FIG. 4, is positioned on an underside of the ramp portion 12. The height adjusting plate 28 is a rectangular-shaped plate attached to the underside of the ramp portion 12. Each of the second ends 26 of the first and second biasing springs 20a, 20b bear on the lower edge of the height adjusting plate 28. As depicted in FIG. 4, the height adjusting plate 28 can be attached to the underside of the ramp portion 12 by a pair of bolts 17a, 17b secured by corresponding washers 19a, 19b and nuts 23a, 23b. However, as will be appreciated by those skilled in the art, any attachment means for securing the height adjusting plate 28 to the ramp portion 12 can be used.

The height adjusting plate 28 is configured to maintain the desired height of the ramp portion 12 when in the neutral position. The ramp portion 12 may include a plurality of different positions for securing the bolts 17a, 17b at different heights to allow each of the second ends 26 of the first and second biasing springs 20a, 20b to move up and down. This movement in height of the second ends 26 allows for the height of the ramp portion 12 to be adjusted when in the neutral position.

As shown in FIG. 1, the ramp portion 12 is maintained in the neutral position when attached to the trailer 150. In this position, the first and second biasing springs 20a, 20b maintain the ramp portion 12 at an elevated height above the ground. In operation, to load or unload a vehicle or cargo using the loading assembly 100, a user can load the vehicle or other wheeled apparatus, such as a dolly, by approaching the ramp portion 12. Once a wheel of the vehicle or apparatus contacts the ramp portion 12, the force of the object pushes the ramp portion 12 downward to the loading position such that the vehicle or apparatus can be rolled up the ramp portion 12. After the vehicle or apparatus is loaded onto the trailer 150, the first and second biasing springs 20a, 20b lift the ramp portion 12 back up to the neutral position (for example, to the desired elevated height) via the height adjustable plate 28.

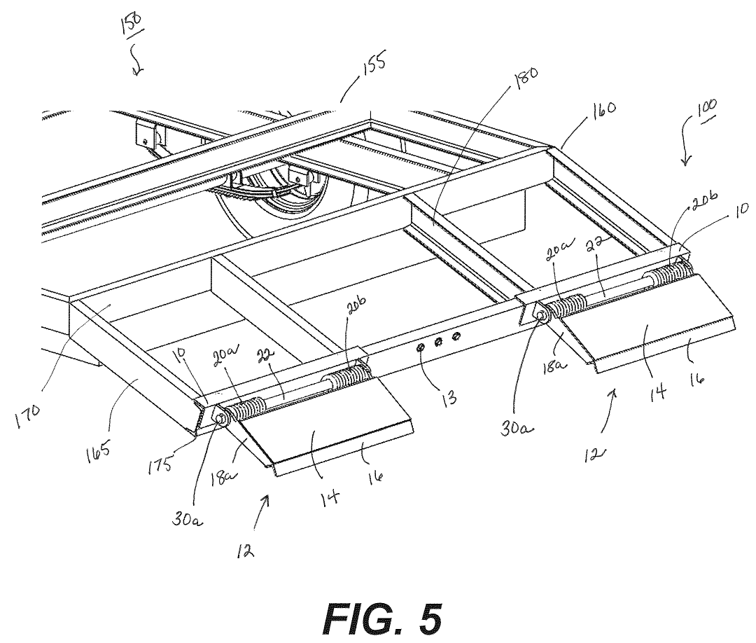

The size and dimensions of the loading assembly 100 can be easily modified to fit differing applications and trailers/trucks of different sizes. For instance, the loading assembly 100 can be dimensioned to fit any type of trailer from small utility trailers to large deckover-style trailers. In another embodiment, as illustrated in FIG. 5, the loading assembly 100 can also be split into multiple assemblies (rather than a full-length assembly as shown in FIG. 1). The loading assembly 100 operates in the same manner as described above; however, as shown in FIG. 5, the loading assembly 100 is comprised of two separate ramp portions 12, each having their own hinge mechanism. The first ramp portion 12 is attached to a left portion of the rear cross member 175 and the second ramp portion 12 is attached to a right portion of the rear cross member 175. Each ramp portion 12 may include its own bracket 10 for attachment to the rear cross member 175. Any of the attachment mechanisms described above may be used to secure the ramp portions 12 to the rear cross member 175. In addition, while two separate ramps are shown in FIG. 5, the loading assembly 100 may include any number of separate ramp portions depending on the application and trailer type.

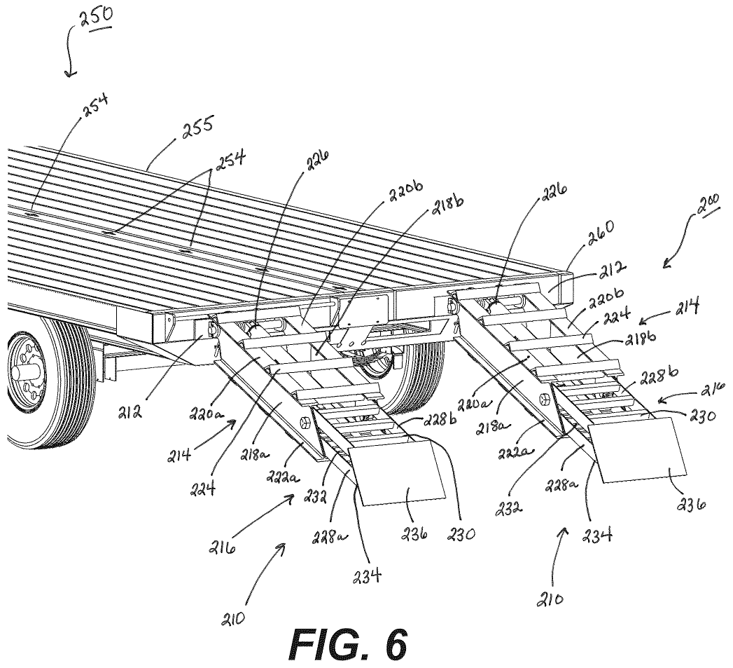

FIGS. 6-10 show a loading assembly 200 according to another embodiment of the present disclosure. Like the loading assembly 100, the loading assembly 200 is configured for attachment to a trailer or a bumper or rear of a vehicle, such as a truck or tractor. In some embodiments, the loading assembly 200 shown in FIGS. 6-10 may be useful for loading or unloading vehicles or equipment that are heavy and/or bulky.

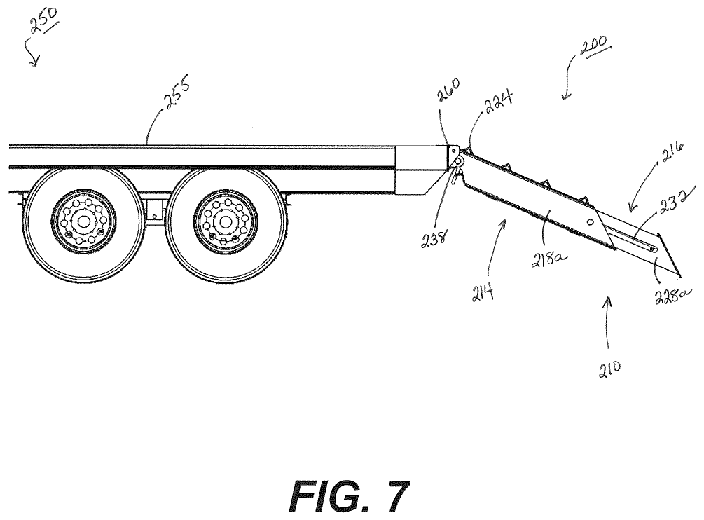

As illustrated in FIGS. 6 and 7, the loading assembly 200 is configured for attachment to a trailer 250. The trailer 250 includes a flatbed portion 255 having a bumper 260. The flatbed portion 255 may have a plurality of anchor points 254 positioned down the center. The anchor points 254 can be used with different hooks or tie-offs to secure cargo. The loading assembly 200 is configured for attachment to the bumper 260 of the trailer 250. For purposes of illustration, the trailer 250 shown in FIGS. 6 and 7 is a flatbed trailer; however, the loading assembly 200 may be used with any type of trailer. In addition, although FIGS. 6 and 7 depict a trailer, the loading assembly 200 can be configured for attachment to a truck or in other circumstances where it is desirable to have a ramp attached thereto. For instance, the loading assembly 200 could be configured for attachment to a bumper or rear of a vehicle, such as a truck or tractor.

The loading assembly 200 includes two separate ramp portions 210, each ramp portion 210 pivotally connected to an attachment plate 212. The attachment plate 212 is configured for attachment to the bumper 260 of the trailer 250. In one embodiment, the attachment plate 212 may be attached to the bumper 260 with fasteners, such as bolts, screws, or rivets. In this embodiment, the attachment plate 212 may include a plurality of holes (not shown) configured for insertion of a fastener. For example, the attachment plate 212 may be bolted to the bumper 260. In another embodiment, the attachment plate 212 may be screwed to the bumper 260. In further embodiments, the attachment plate 212 may be welded to the bumper 260. In still further embodiments, the attachment plate 212 may be adjustably attached to the bumper 260 so that the positioning of the ramp portion 210 can be adjusted to set a desired track width. In this embodiment, the ramp portion 210 can be laterally shifted to a multiplicity of positions across the width of the bumper 260 as desired. The attachment plate 212 can also be adjusted in size (for example, the width and/or length) to allow the ramp portions 210 to slide along the width of the bumper 260 to provide for adjustment.

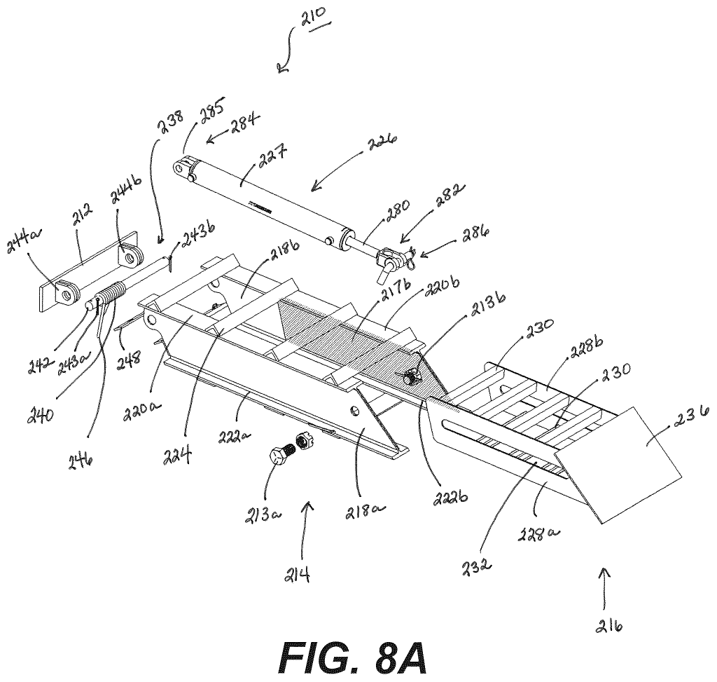

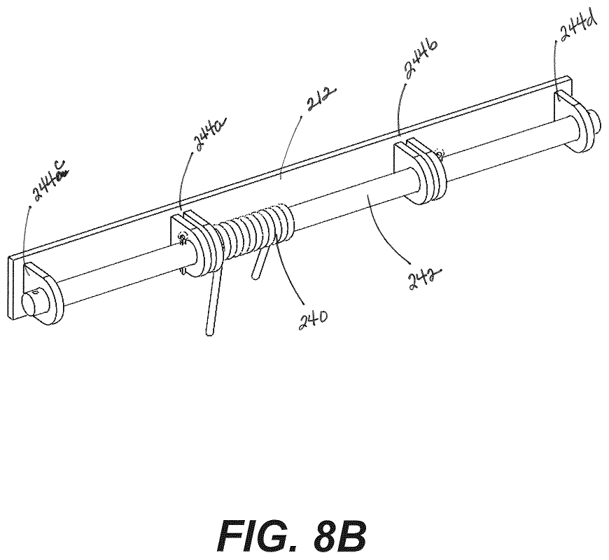

The ramp portions 210 are each formed of a base 214 and an extender 216 coupled thereto. The base 214 is comprised of two generally parallel spaced apart side plates 218a, 218b, each side plate 218a, 218b having a top surface 220a, 220b and an opposed bottom surface 222a, 222b. Each side plate 218a, 218b includes an inner layer 217a, 217b that may be formed of plastic for additional strength and durability. In some embodiments, the inner layer 217a, 217b may be formed of polyethylene, such as ultra-high-molecular-weight polyethylene (UHMWPE). The top surfaces 220a, 220b are planar, and the bottom surfaces 222a, 222b are also planar and parallel to the top surfaces 220a, 220b. A plurality of cross-treads 224 extends between the side plates 218a, 218b and are attached at the top surfaces thereof 220a, 220b. As shown in FIGS. 6 and 8A, the cross-treads 224 are generally triangular to provide for traction as the vehicle or wheeled apparatus is loaded onto the trailer 250. However, the cross-treads 224 may be any shape that allows for vehicles and/or cargo to be loaded or unloaded. In some embodiments, the cross-treads 224 may include a non-skid surface, such as those described above.

The side plates 218a, 218b (and the top surfaces 220a, 220b and bottom surfaces 222a, 222b) on the base 214 are generally sloped to form an incline. The incline facilitates a smooth loading and unloading process. In some embodiments, the base 214 may be formed at an angle of about 5 degrees to about 20 degrees. In another embodiment, the base 214 may be formed at an angle of about 7 degrees to about 15 degrees. In still another embodiment, the base 214 may be formed at an angle of about 8 degrees to about 10 degrees.

The extender 216 is movably coupled to the base 214. In one embodiment, the extender 216 is extendable from the base 214. This is particularly advantageous when the height of the trailer to which the loading assembly is to be attached is taller than the height of base 214. In this embodiment, the extender 216 can be extended from the base 214 to provide for an extended ramp surface. As will be described in more detail below, the extender 216 can be extended from the base 214 using an actuating mechanism 226.

The extender 216 is comprised of two generally parallel spaced apart side plates 228a, 228b having a plurality of upper and lower cross-treads 230 extending therebetween. Each side plate 228a, 228b includes a longitudinal slot 232. The longitudinal slot 232 is used to connect the extender 216 to the base 214 and facilitate extension of the extender 216 from the base 214. As shown in FIG. 8A, the base 214 includes bolts 213a, 213b that extend through each of side plates 218a, 218b (and inner layers 217a, 217b) respectively and into the longitudinal slots 232 to act as a stop and prevent the extender 216 from getting misaligned as it is slid in and out of the base 214. A front end 234 of the extender 216 includes a front plate 236. The front plate 236 is downwardly angled with respect to the extender 216 such that the front plate 236 is adapted for facilitating transition of the vehicle or wheeled apparatus from the ground surface to the ramp portion 210.

The ramp portions 210 are pivotally connected to the attachment plates 212 to allow for the ramp portions 210 to pivot between a neutral position and a loading position in a similar manner as described above with respect to the loading assembly 100. The neutral position is shown in FIGS. 6 and 7. In the neutral position, the ramp portions 210 are elevated above the ground surface. For instance, in the neutral position, the ramp portions 210 may be elevated anywhere from about one inch to about twenty-four inches off the ground surface. In another embodiment, the ramp portions 210 may be elevated about three inches to about twenty inches off the ground surface. In still another embodiment, the ramp portions 210 may be elevated about six inches to about fifteen inches off the ground surface. However, in the neutral position, the ramp portions 210 should be no lower than the height of the axle of the trailer 150. In the loading position, the ramp portions 210 pivot downward such that the front plates 236 are level with the ground surface to allow for vehicles and other cargo to be loaded on the trailer. For instance, the ramp portions 210 may be flush with the ground surface. Once loading is complete, the ramp portions 210 pivot upward to the neutral position. In some embodiments, movement of the ramp portions 210 between the loading position and the neutral position is performed with the use of a spring-assisted hinge mechanism 238.

The hinge mechanism 238 pivotally couples the ramp portion 210 to the attachment plate 212. As best shown in FIG. 8A, the hinge mechanism 238 includes a biasing spring 240. In one embodiment, the biasing spring 240 is a heavy duty helical elongated coil spring. The biasing spring 240 is coiled around a hinge pin 242. The hinge pin 242 extends through two brackets 244a, 244b that are mounted on the attachment plate 212. Pins 243a, 243b, such as cotter pins, can extend through the hinge pin 242 and be used to secure the hinge pin 242 to the brackets 244a, 244b. A first end 246 of the biasing spring 240 bears on a lower edge of a height adjusting plate 248. The biasing spring 240 is tensioned when the ramp portion 210 is in the loading position while the biasing spring 240 is unloaded in the neutral position. In other words, the biasing spring 240 of the hinge mechanism 238 biases the ramp portion 210 toward the neutral position. As depicted in FIG. 8B, the width of the attachment plate 212 can also be extended to utilize additional brackets, such as brackets 244c, 244d, to mount a longer hinge pin 242 depending on the size of the attachment plate 212 and the ramp portion 210.

In operation, the ramp portion 210 is maintained in the neutral position when attached to the trailer 250. In this position, the biasing spring 240 maintains the ramp portion 210 at an elevated height above the ground. To load or unload a vehicle or cargo using the loading assembly 200, a user can load the vehicle or other wheeled apparatus, such as a dolly, by approaching the ramp portion 210. Once a wheel of the vehicle or apparatus contacts the ramp portion 210 (for example, the front plate 236), the force of the object pushes the ramp portion 210 downward to the loading position such that the vehicle or apparatus can be rolled up the ramp portion 210. After the vehicle or apparatus is loaded onto the trailer 250, the biasing spring 240 lifts the ramp portion 210 back up to the neutral position (for example, to the desired elevated height) via the height adjustable plate 248.

Each ramp portion 210 also includes actuating mechanism 226 for extending and retracting the extender 216 from the base 214. As shown in FIG. 8A, the actuating mechanism 226 is a pneumatic or hydraulic cylinder 227. The pneumatic or hydraulic cylinder 227 is operatively connected to a rod 280. For example, the rod 280 is movable within the pneumatic or hydraulic cylinder 227 to extend and retract the extender 216 from the base 214. A distal end 282 of the rod 280 may be operatively connected to a portion of the extender 216. For example, in one embodiment, the distal end 282 of the rod 280 may be operatively connected to one of the lower cross-tread 230. As shown in FIG. 8A, the distal end 282 may include a linking element 286, such as a linkage fork, for attaching the rod 280 to the extender 216. A proximal end 284 of the actuating mechanism 226 may be operatively connected to the hinge pin 242, for instance, by a linking element 285.

While the actuating mechanism 226 is illustrated as a pneumatic or hydraulic cylinder, the actuating mechanism 226 may be any suitable actuating device, such as, for example, a hydraulic piston, an electronic actuator, a step motor, an electronic winch, a hydraulic winch, a manual winch, an air bag, a pneumatic actuator, an air cylinder, a linear actuator, a mechanical jack, a hydraulic jack, a hydraulic pump, or any other type of mechanism that imparts linear motion. The actuating mechanism 226 may be manually operated or automatically operated. For example, in some embodiments, the actuating mechanism 226 is a manually operated pneumatic or hydraulic cylinder that uses air from the vehicle to which the trailer 250 is attached. In another embodiment, the actuating mechanism 226 may be an electric actuator.

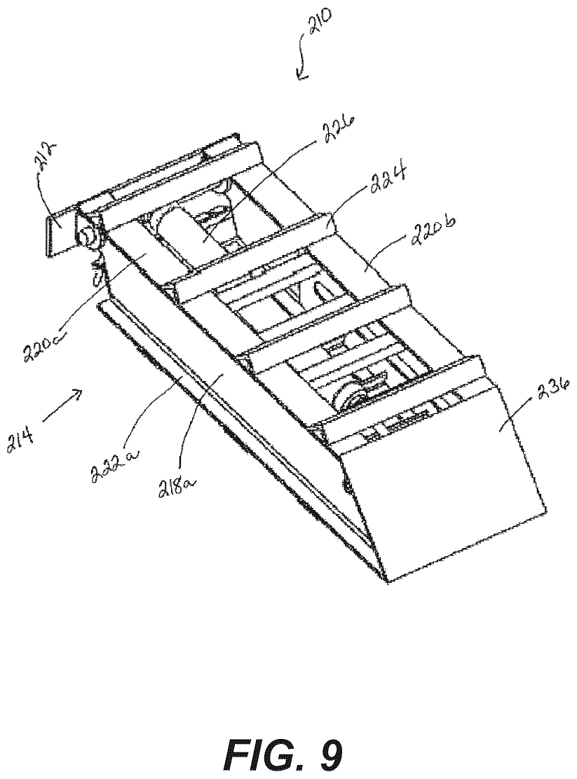

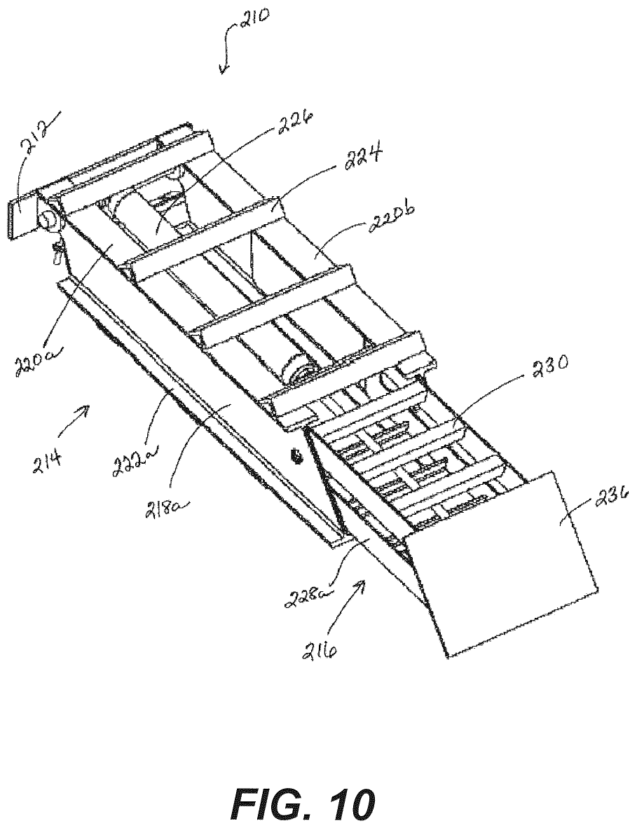

FIGS. 9 and 10 show the ramp portion 210 in a retracted or stowed position and in an extended position, respectively. As shown in FIG. 9, in the retracted or stowed position, the extender 216 is positioned inside the base 214. As discussed above, the ramp portion 210 can be used in the retracted or stowed position when the height of the trailer is able to accommodate the height of the base 214. However, when the height of the trailer is taller than the height of base 214, the extender 216 can be extended from the base 214 to provide for an additional length of ramp surface, as illustrated in FIG. 10.

The size and dimensions of the loading assembly 200 can be easily modified to fit differing applications and trailers / trucks of different sizes. For instance, rather than being split into separate ramp portions, the ramp portion 210 of the loading assembly 200 can be provided as a full-length assembly that extends across the entire width of the bumper 260. In addition, while two separate ramps are shown in FIGS. 6 and 7, the loading assembly 200 may include any number of separate ramp portions depending on the application and trailer type.

The various components of the loading assemblies described herein may be constructed or manufactured from materials, such as various polymers, plastics, stainless steel, aluminum, and combinations thereof. Similarly, the various parts described herein may be constructed according to various manufacturing methods including injection molding, milling, forging, extrusion, pressing, 3D printing, and other related manufacturing methods.

The loading assemblies described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the loading assemblies in addition to those shown and described herein will become apparent to those skilled in the art from the foregoing description. Such modifications are also intended to fall within the scope of the disclosure. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A loading assembly for attachment to a trailer or vehicle, comprising:
a bracket,
a ramp portion pivotally coupled to the bracket, wherein the ramp portion is pivotally coupled to the bracket by a hinge mechanism,
wherein the hinge mechanism comprises a hinge pin and a first biasing spring and a second biasing spring disposed around the hinge pin, and the first and second biasing springs are unloaded when the ramp portion is in a neutral position and the first and second biasing springs are tensioned when the ramp portion is in a loading position, and
wherein the hinge mechanism facilitates movement of the ramp portion between the neutral position in which the ramp portion is elevated above a ground surface and the loading position in which the ramp portion is level with the ground surface.

2. The loading assembly of claim 1, further comprising a height adjusting plate configured for attachment to an underside of the ramp portion at adjustable heights.

3. The loading assembly of claim 1, wherein the hinge pin is mounted between the bracket and the ramp portion.

4. The loading assembly of claim 1, wherein the ramp portion is elevated at a height equal to or greater than a height of an axle of the trailer or vehicle when in the neutral position.

5. The loading assembly of claim 1, wherein the ramp portion comprises a lip configured to be flush with the ground surface in the loading position.

6. The loading assembly of claim 2, wherein an end of the first and second biasing springs bear on a lower edge of the height adjusting plate.

7. A loading assembly for attachment to a trailer or vehicle, comprising:
an attachment mechanism,
a ramp portion comprising a base and an extender coupled to the base, wherein the base is pivotally coupled to the attachment mechanism by a biasing spring,
an actuating mechanism operatively attached to the base and the extender, wherein the actuating mechanism is configured to facilitate extension of the extender from the base,
wherein the biasing spring is unloaded when the ramp portion is in a neutral position and the biasing spring is tensioned when the ramp portion is in a loading position, and the biasing spring facilitates movement of the ramp portion between the neutral position in which the ramp portion is elevated above a ground surface and the loading position in which the ramp portion is level with the ground surface.

8. The loading assembly of claim 7, wherein the attachment mechanism comprises a bracket or a plate configured for attachment to the trailer or vehicle.

9. The loading assembly of claim 7, wherein each of the base and the extender comprises a plurality of cross-treads extending therebetween.

10. The loading assembly of claim 7, wherein the extender is configured to move between a stowed position in which the extender is positioned inside the base and an extended position in which the extender is extended outwardly from the base.

11. The loading assembly of claim 7, wherein the actuating mechanism comprises a linear actuator.

12. The loading assembly of claim 11, wherein the actuating mechanism comprises a pneumatic or hydraulic cylinder operatively connected to a movable rod.

13. The loading assembly of claim 12, wherein the movable rod is operatively attached to the extender.

14. The loading assembly of claim 7, wherein the extender comprises a front plate configured to be flush with the ground surface in the loading position.

15. A trailer, comprising:
a substantially flat bed having a rear bumper,
a ramp portion pivotally coupled to the rear bumper by a hinge mechanism, wherein the ramp portion comprises a base and an extender coupled to the base,
an actuating mechanism operatively attached to the base and the extender, wherein the actuating mechanism is configured to facilitate extension of the extender from the base, the actuating mechanism comprising a linear actuator,
wherein the hinge mechanism comprises a hinge pin and at least one biasing spring disposed around the hinge pin, and the at least one biasing spring is unloaded when the ramp portion is in a neutral position and is tensioned when the ramp portion is in a loading position, and
wherein the hinge mechanism facilitates movement of the ramp portion between the neutral position in which the ramp portion is elevated above a ground surface and the loading position in which the ramp portion is flush with the ground surface.

16. The trailer of claim 15, wherein the actuating mechanism comprises a pneumatic or hydraulic cylinder operatively connected to a movable rod.

17. The trailer of claim 16, wherein the movable rod is operatively attached to the extender.

18. The trailer of claim 15, further comprising a height adjusting plate configured for attachment to an underside of the ramp portion at adjustable heights, wherein an end of the at least one biasing spring bears on a lower edge of the height adjusting plate.

19. The trailer of claim 15, wherein the ramp portion is elevated at a height equal to or greater than a height of an axle of the trailer when in the neutral position.

20. The trailer of claim 15, wherein each of the base and the extender comprises a plurality of cross-treads extending therebetween.
